(19) United States
(12) Patent Application Publication
(10) Pub. No.: US 2009/0083141 A1
(43) Pub. Date: Mar. 26, 2009

(54) METHODS, SYSTEMS, AND COMPUTER PROGRAM PRODUCTS FOR DETECTING AND PREDICTING USER CONTENT INTEREST

(76) Inventor: Ari Craine, Marietta, GA (US)

Correspondence Address: AT&T Legal Department;Attn: Patent Docketing, Room 2A-207, One AT&T Way, Bedminster, NJ, 07921, US

(21) Appl. No.: 11/860,790

(22) Filed: Sep. 25, 2007

(51) Int. Cl. G06Q 30/00; G06F 17/30; G06F 17/40

(52) U.S. Cl. 705/14; 705/1

(57) ABSTRACT

Methods, systems and computer program products detect and predict user content interest include receiving user consumption artifacts from one or more behavioral sources. The received user content consumption artifacts are analyzed by an interest engine and a user-specific content interest list and a potential content playlist are generated for a particular user. The user content interest list is a listing of the types of content the particular user is interested in. The potential content playlist identifies currently available content that is of interest to the user. The content interest list and potential content playlist are communicated to the user. Future content that matches a user-specific content interest list is identified and the user is alerted to the identified future content. Hypothetical content that a user might be interested and would most likely consume if available may also be identified.

### FIELD OF THE APPLICATION

The present application relates generally to communications networks, and, more particularly, to methods, systems, and computer program products for obtaining content via communications networks.

### BACKGROUND

Communications networks are widely used for nationwide and worldwide communication of voice, multimedia and/or data. As used herein, the term “communications networks” includes public communications networks, such as the Public Switched Telephone Network (PSTN), terrestrial and/or satellite cellular networks, private networks and/or the Internet.

The Internet is a decentralized network of computers that can communicate with one another via Internet Protocol (IP). The Internet includes the World Wide Web (web) service facility, which is a client/server-based facility that includes a large number of servers (computers connected to the Internet) on which web pages or files reside, as well as clients (web browsers), which interface users with the web pages. The topology of the web can be described as a network of networks, with providers of network services called Network Service Providers, or NSPs. Servers that provide application-layer services may be referred to as Application Service Providers (ASPs). Sometimes a single service provider provides both functions.

Vast amounts of information or “content” are available on the web including, but not limited to text, images, applications, video, and audio content. Web users are also increasingly making their own personal content (e.g., home movies, photograph albums, audio recordings, etc.) available via the web through web sites, web logs (blogs), and the like. In addition, television networks, including traditional broadcast networks as well as cable and satellite television networks, are making content available via the web. Unfortunately, the sheer amount of available content and the increasing numbers of content providers are posing increasingly more difficult challenges to users with respect to finding content of interest.

### SUMMARY

According to exemplary embodiments, systems, methods, and computer program products are provided that facilitate detecting and predicting user content interest. According to some embodiments, a method of detecting and predicting user content (e.g., text, video, audio, etc.) interest includes receiving user consumption artifacts from one or more behavioral sources. Exemplary behavioral sources include, but are not limited to online content sources, content sources available via stationary media devices, content sources available via mobile media devices, and content sources available at the point of sale of goods and services. Additional content sources include content interest lists of other users and content alert messages sent to other users. Received user content consumption artifacts are analyzed by an interest engine and a user-specific content interest list and a potential content playlist are generated for the user. The user content interest list is a listing of the types of content the particular user is interested in, and may be a prioritized listing. The potential content playlist identifies currently available content that is of interest to the user (i.e., content that is identified that would most likely be of interest to the user). The content interest list and potential content playlist are communicated to the user.

In some embodiments, future content that matches a user-specific content interest list is identified. The user is then alerted to the identified future content. Alert messages may be sent to one or more user devices that identifies a time and location of the future content. In some embodiments, an alert message is sent to a user device where the user is currently active. For example, if the user is within a vehicle, an alert message may be communicated to a device within the vehicle.

In some embodiments, hypothetical content that a user might be interested and would most likely consume if available is identified. For example, the interest engine may understand that a user likes movies in the genre of “westerns” and also likes movies that the actor George Clooney is in. The interest engine may make a hypothetical recommendation that the user may like a western movie with the actor George Clooney. As such, the interest engine may monitor future available content, as well as currently available content, for any westerns including the actor George Clooney.

In some embodiments, other users may subscribe to user-specific content interest lists, potential content playlists, and/or content alert messages sent to other users.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which form a part of the specification, illustrate some exemplary embodiments. The drawings and description together serve to fully explain the exemplary embodiments.

FIG. 1 is a block diagram that illustrates a software/hardware architecture for detecting and predicting user content interest, according to some embodiments.

FIG. 2 is a flowchart that illustrates exemplary operations for detecting and predicting user content interest, according to some embodiments.

FIG. 3 is a block diagram that illustrates a processor and a memory hosted by a device that may be used to implement an interest engine, according to some embodiments.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, steps, operations, elements, and/or components, but does not preclude the presence or addition of one or more other features, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments may be implemented as systems, methods, and/or computer program products. Accordingly, the exemplary embodiments may be implemented in hardware and/or in software, including firmware, resident software, micro-code, etc. Furthermore, exemplary embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: a portable computer diskette, a random access memory (RAM), a read-only memory (ROM), an erasable programmable read-only memory (EPROM or Flash memory), and a portable compact disc read-only memory (CD-ROM).

As used herein, the term “content” means any type of audio information, video information, audio/video information, text, gaming information, interactive information, application information, etc., that can be delivered and/or performed/displayed via a communications network. For example, content may include television programs, movies, voice messages, music and other audio files, electronic mail/messages, web pages, interactive games, educational materials, software applications, etc.

Computer program code for carrying out operations of data processing systems discussed herein may be written in a high-level programming language, such as Java, AJAX (Asynchronous JavaScript), C, and/or C++, for development convenience. In addition, computer program code for carrying out operations of exemplary embodiments may also be written in other programming languages, such as, but not limited to, interpreted languages. Some modules or routines may be written in assembly language or even micro-code to enhance performance and/or memory usage. Exemplary embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

Exemplary embodiments are described herein with reference to flowchart and/or block diagram illustrations of methods, systems, and computer program products in accordance with exemplary embodiments of the invention. These flowchart and/or block diagrams further illustrate exemplary operations for detecting and predicting user content interest via a communications network, in accordance with some embodiments. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks. The computer program instructions can be executed within the interest engine described below and/or within any user device.

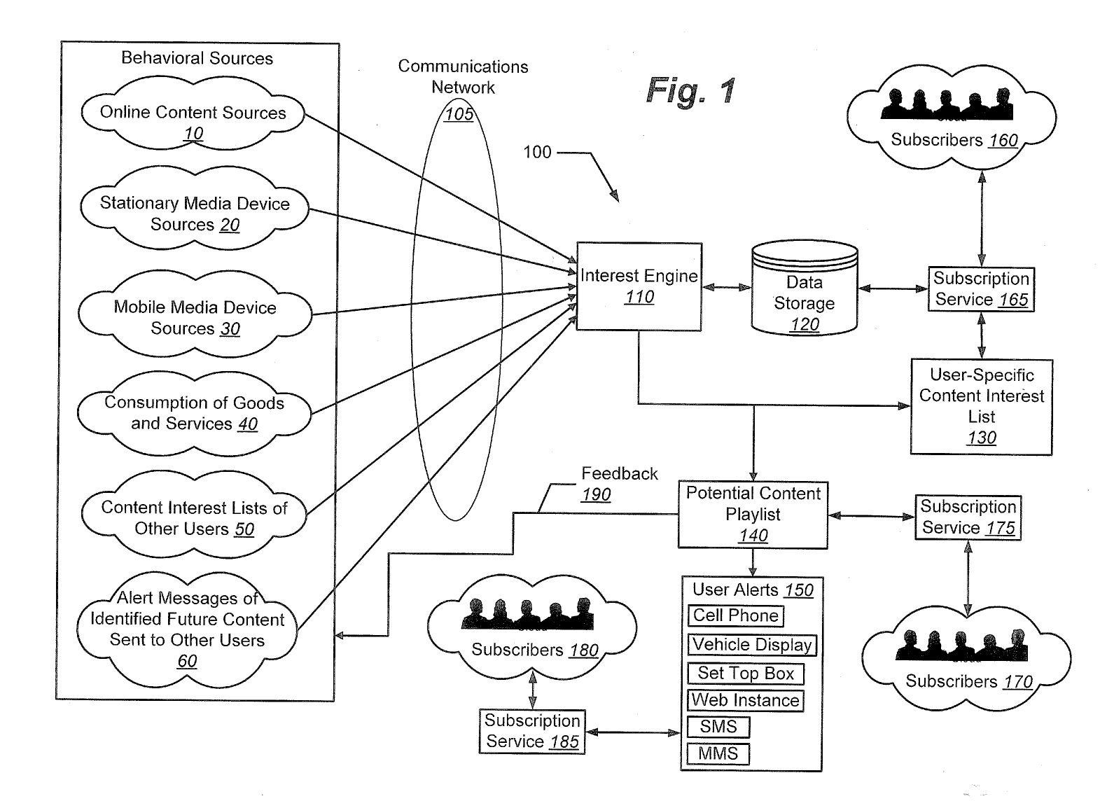

Referring to FIG. 1, a system 100 for detecting and predicting user content interest, according to some embodiments, is illustrated. The illustrated system 100 includes an interest engine 110 that is configured to receive, via a communications network 105, user content consumption artifacts from one or more behavioral sources, to analyze received user content consumption artifacts, and to generate a user-specific content interest list and a potential content playlist for the user. Communications network 105 may be the Internet or other publicly accessible network, a wide area network, a local area network, an Intranet, or other private network, etc. Communication network 105 may also include a combination of public and private networks or a virtual private network (VPN). Communications via the communication network 105 may occur over-the-air and/or through a dedicated distribution network. The illustrated communications network 105 is intended to include all possible types of communications networks, without limitation.

A user content consumption artifact, as used herein, is identifying information about content including, but not limited to, content title, content source location, content subject, time of content consumption, type of content, etc.

User content consumption artifacts may be obtained from one or more of various behavioral sources including, but not limited to, online content sources 10, stationary media device sources 20, mobile media device sources 30, point of purchase locations for goods and services 40, content interest lists of other users 50, and content alert messages of identified future content sent to other users 60. Each of these behavioral sources is described below.

Online content sources 10 include virtual sources of content accessible by a user via the internet, etc. Examples of online content include, but are not limited to, text, images, video, and audio content from online web sites, FTP sites, etc. For example, a user may consume video content from YouTube.com. A user may store and/or access content links via Del.icio.us. A user may access business content from Factiva.com, etc. Stationary media device sources 20 include, but are not limited to, televisions, set top boxes, radios, storage devices, etc. Content via stationary media device sources includes, but is not limited to, television programming, radio programming, and other media services. For example, high definition (HD) television content, such as HBO HD and NFL Ticket, is available via a set top box connected to a television or computer. Content sources also include storage devices, such as digital video recorders (DVRs) and other devices configured to record and store audio and video content. Additional stationary media device content sources include devices associated with the home environment, such as home networks and/or security systems. For example, the security cameras of a home security system can be a source of content.

Mobile media devices (30, FIG. 1) through which users can access content include, but are not limited to, cell phones, cameras, automobiles, and proximity-based devices (e.g., Bluetooth® devices, WIFI devices, etc.). In addition to text information, various types of audio and video content can be received via cell phones. Users also can create and store content via cameras and other portable devices. The types of content a user can access in a vehicle include, but are not limited to, audio content via a radio and/or CD, and audio/video content via a DVD. Additional content includes input and output from a navigational system.

Other behavioral sources of content may be provided anywhere a user consumes a service or product (40, FIG. 1). For example, a content consumption artifact can be generated when a user purchases movie tickets (e.g., when the user uses her credit/debit card or when the user uses cash if information about the user is collected electronically at the point of purchase). In addition to identifying that the particular user “consumed” movie content, such an artifact may include information about the particular movie the user purchased tickets for (e.g., actors, plot, genre, etc.). The artifact may, thereby, indicate that the user may be interested in future content associated with one or more aspects of the movie.

As another example, a content consumption artifact may be created when a user purchases (e.g., when the user uses her credit/debit card or when the user uses cash if information about the user is collected electronically at the point of purchase) a Yoga class card at the local gym. In addition to identifying that the user “consumed” a Yoga class, such an artifact may include information about the type of physical activity (and content about physical activity) the user is interested in. As another example, a content consumption artifact may be created when a user purchases (e.g., when the user uses her credit/debit card or when the user uses cash if information about the user is collected electronically at the point of purchase) a book or magazine. The artifact may include information about the content of the book or magazine and thereby indicate that the user may be particularly interested in the type of content in the book or magazine.

Additional sources of content include content interest lists of other users 50 and content alert messages sent to other users 60. These content sources are discussed below.

As previously mentioned, as a user accesses/receives content from one or more of the various behavioral sources described above, content consumption artifacts are created. These artifacts are created using metadata that comes with the content. For example, online content includes metadata that describes the content, as would be known to those skilled in the art. Audio content and video content also includes identifying information or metadata that can be displayed/accessed, as would be known to those skilled in the art. For example, audio music content typically includes identifying information such as “artist” and “title”, etc.

According to some embodiments, if a user records an Atlanta Braves baseball game on her DVR, an artifact is created that not only identifies information about the broadcast game but also indicates that the user may like baseball and/or the Atlanta Braves. Similarly, if a user watches a Robert Redford movie on HBO HD, an artifact is created that indicates that the user may like Robert Redford. Over time, as artifacts are created, user content behavioral patterns begin to emerge that are recognized by the system 100 and allow the system 100 to determine and locate existing and/or future content for a user that the user is interested in consuming.

The interest engine 110 is configured to collect content consumption artifacts for a user and then analyze these artifacts to determine what type of content this particular user wants to consume. Artifact analysis may include artifact comparisons, prioritizations, triage (i.e., sorting types of content), etc. For example, the interest engine 110 may compare artifacts to determine what type of content is of more interest to a user than other content types. The interest engine 110 may assign different priorities to different content based on user content consumption habits. The output of the interest engine 100 can be thought of as content that is “most likely to succeed.” Content “most likely to succeed” is content that a user has an interest in and wants to consume.

The interest engine 110 may factor in the number of times a user consumes particular types of content. For example, if a user records seventy five (75) Atlanta Braves baseball games over the course of a season, the interest engine 110 can conclude that this particular user will likely want to consume content associated with the Atlanta Braves and/or baseball in general. If the same user records only one Atlanta Falcons football game over the course of a season, the interest engine 110 may not be able to conclude whether or not this user will likely want to consume other content associated with the Atlanta Falcons or football in general. It may be the case that the user does want to consume content associated with the Atlanta Falcons and/or football. However, a single artifact (i.e., the recording of a single game) may be an insufficient number of data points to make this conclusion.

According to some embodiments, the interest engine 110 is configured to hypothesize about content that a user may want to see in the future, but that may not exist at the present time. For example, if the interest engine 110 deduces that a user likes movies with actors Robert Redford and Paul Newman, the interest engine 110 may hypothesize that the user will like to consume content in the future associated with both of these actors, whether it be a movie, television show, play, etc. The interest engine 110 may store this information for use in identifying qualifying future content, and/or may communicate this information to the user.

In some embodiments, the interest engine 110 may be part of a web server or other online device. The web server may be located in or behind a communications network or “cloud” infrastructure. In some embodiments, the interest engine 110 may be located on a user's device (computer, cell phone, etc.).

In the illustrated embodiment, analysis of content consumption artifacts by the interest engine 110 may be stored within data storage 120. Data storage may be anonymous data storage such that other users accessing stored information cannot identify particular users. Data storage 120, according to embodiments, can have various tables and structures, without limitation. Data storage 120 can be included in the interest engine, for example behind a communications network or “cloud” infrastructure, and/or local to subscriber devices.

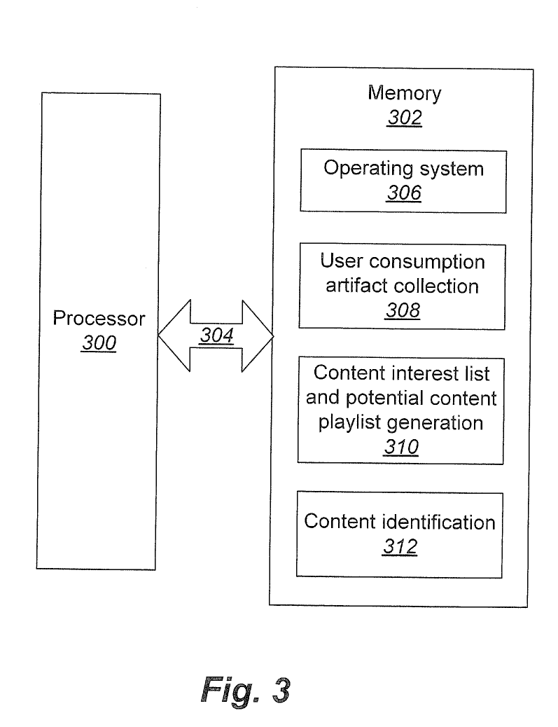

FIG. 3 illustrates a processor 300 and a memory 302 hosted by a device that may be used in embodiments of methods, systems, computer networks, and computer program products for implementing an interest engine (110, FIG. 1). The processor 300 communicates with the memory 302 via an address/data bus 304. The processor 300 may be, for example, a commercially available or custom microprocessor. The memory 302 is representative of the overall hierarchy of memory devices containing the software and data used to implement an interest engine as described herein, in accordance with some embodiments. The memory 302 may include, but is not limited to, the following types of devices: cache, ROM, PROM, EPROM, EEPROM, flash, SRAM, and DRAM.

As shown in FIG. 3, the memory 302 may hold various categories of software and data: an operating system 306, a user consumption artifact collection module 308, a content interest list and potential content playlist generation module 310, and a content identification module 312. The operating system 306 controls operations of a device hosting the interest engine (or a portion of the interest engine). In particular, the operating system 306 may manage a device's resources and may coordinate execution of various programs (e.g., the user consumption artifact collection module, content interest list and potential content playlist generation module, and content identification module, etc.) by the processor 300.

The user consumption artifact collection module 308, comprises logic for collecting user consumption artifacts from one or more behavioral sources, as illustrated in FIG. 1. Content interest list and potential content playlist generation module 310 comprises logic for generating a user-specific content interest list from received user consumption artifacts, and logic for generating a potential content playlist for a user from the user-specific content list. As described above, the potential content playlist identifies currently available content that is of potential interest to a user. Content identification module 312 comprises logic for identifying future content that matches a user-specific content interest list and logic for identifying hypothetical content that a user is likely to want to consume.

According to some embodiments, one output of the interest engine 110 is a “user-specific content interest list” 130 for a particular user. The user-specific content interest list identifies the types of content that a particular user is interested in, and may be in prioritized order. For example, a user-specific content interest list may specify that a user likes Robert Redford movies, Atlanta Braves baseball, books authored by John Grisham, music by the Rolling Stones, and Yoga-related information. This content interest list may be communicated to the user and also may be stored, for example anonymously, within data storage 120. As described below, content interest lists of users may be syndicated to other users. In other words, content interest lists of users may be “subscribed to” by other users. In addition, in some embodiments, content interest lists may be presented to users for editing/modification/additions. Such edits/modifications/additions can then become one of the behavioral sources. This allows a user to add information that may not otherwise be available from the content or content source, alone.

Another output of the interest engine 110, according to some embodiments, is a “potential content playlist” 140 for a particular user. A potential content playlist is a list of future content that matches the user-specific content interest list 130 (i.e., identified future content that matches what a user is interested in). For example, if a user's content interest list includes an indication that the user likes content associated with actress Drew Barrymore, the potential content playlist will look for any future content associated with this actress. If it is learned (for example by scanning future television programming guides, etc.) that Drew Barrymore is going to appear on the David Letterman television show in two weeks, an alert is generated and transmitted to the user. This content alert identifies to the user the future content and provides additional information, such as the time and channel of the future content.

As illustrated by 190 in FIG. 1, a user's potential content playlist may be fed back to one or more behavioral sources and may suggest new content sources for the user and/or may suggest modification of one or more content sources for the user. In essence, a potential content playlist becomes a behavioral source itself and/or a modifier of other behavioral sources. Furthermore, the system 100 is a dynamic system that changes over time, because user behavior with respect to content will likely change/evolve over time. The system 100 is an intelligent system that learns over time what the most important content is for a specific user. Moreover, the system 100 is configured to identify behavioral changes of users over time.

As illustrated in FIG. 1, user alerts 150 may be communicated to users in various ways including, but not limited to, via a user's cell phone, via a device within a user's vehicle, via a user's set top box, via a web instance (e.g., a web page or other virtual communication), via short message service (SMS) and/or via multimedia message service (MMS). According to some embodiments, user alerts 150 may be sent to all devices associated with a user. Alerts may also be stored within one or more of the devices. In some embodiments, when the user responds to the alert via a particular device, alerts transmitted to the other devices become inactive or dormant.

According to some embodiments, an alert may be sent to a user where the user is “active.” For example, if a user is in her vehicle, an alert may be communicated to the user via a device in the vehicle and/or displayed within a vehicle display. If the user has an activated cell phone, an alert may be communicated to the user via her cell phone.

According to further embodiments, other users may “subscribe” to content information of other users. It is anticipated that such subscriptions are anonymous in that subscribers and content users are not identified to each other. However, other identifying information may be available. For example, the location of a user may be indicated for a user-specific content interest list and/or potential content interest list. Alternatively, a “famous” individual or celebrity may license their content interest list or a portion thereof on a pay-per-use basis, on a subscription basis, etc. For example, users may be interested in what books George Clooney is reading, what television shows George Clooney is watching, etc. Users may also wish to subscribe to content information of combinations of users. For example, a user may wish to subscribe to content information of George Clooney and some other celebrity (or non-celebrity), etc.

As illustrated in FIG. 1, subscribers 160 may subscribe to user-specific content interest lists 130 and/or stored information via a subscription service 165. These subscribers 160 may be interested in the content other users are consuming. For example, subscribers 160 may be interested in the content one or more users in Kodiak, Ak. are consuming. Similarly, subscribers 170 may subscribe to potential content playlists 140 of other users via a subscription service 175. Subscribers to user-specific content interest lists and potential content playlists may combine these with their respective user-specific content interest lists and potential content playlists. This subscription activity, by itself, may serve as a behavioral source that may be utilized by the interest engine 110 for these particular users. As such, embodiments can facilitate content collaboration and syndication among multiple users. Subscribers 180 may subscribe to future content alerts communicated to other users via a subscription service 185. For example, another user interested in content associated with actress Drew Barrymore may subscribe to receive alerts for future content associated with the actress. Although subscribers are illustrated and described above, it should be appreciated that users that are not the actual subscribers, e.g., other members in a subscriber's household, may use and benefit from the subscribed services.

Software code for performing the various functions of the user content interest detection and prediction system 100 may reside and/or execute entirely on a single device connected to a communications network 105, or on multiple devices connected to the communications network 105. Although FIG. 1 illustrates an exemplary content interest detection and prediction system 100, it will be understood that the present invention is not limited to the illustrated modules and configuration, but is intended to encompass any configuration and any modules capable of carrying out the operations described herein.

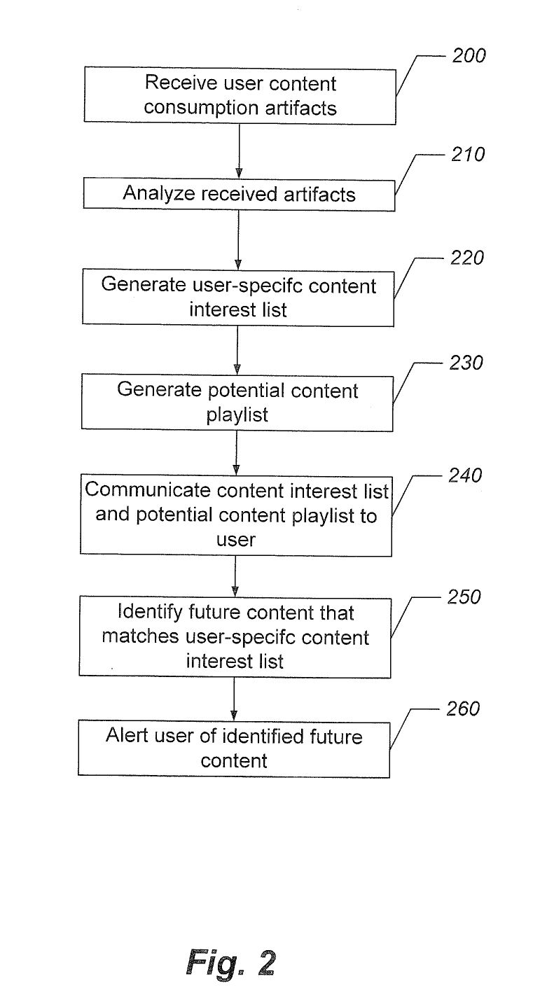

Exemplary operations for detecting and predicting user content interest, according to some embodiments, will now be described with reference to FIG. 2. The following functions are performed by the content interest and prediction system (100, FIG. 1). The interest engine 110 receives user content consumption artifacts from one or more behavioral sources (Block 200). The received artifacts are analyzed to identify content that the user is interested in consuming (Block 210). For example, the received artifacts are analyzed to identify common themes and/or common media types that the user is interested in. In addition, the artifacts may be prioritized on the number of occurrences, etc.

A user-specific content interest list is generated (Block 220) and a potential content playlist that identifies currently available content that is of interest to the user is generated (Block 230). The generated content interest list and potential content playlist are communicated to the user (Block 240). For example, the content interest list and potential content playlist are communicated to various devices of a user, as described above.

The content interest and prediction system 100 may also perform the following functions. Future content that matches the user-specific content interest list for a user is identified (Block 250), and one or more alerts are sent to the user of the identified future content (Block 260).

FIG. 2 illustrates the architecture, functionality, and operations of some embodiments of methods, systems, and computer program products for detecting and predicting user content interest. In this regard, each block represents a module, segment, or portion of code, which comprises one or more executable instructions for implementing the specified logical function(s). It should also be noted that in other implementations, the function(s) noted in the blocks may occur out of the order noted in FIG. 2. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. A method of detecting and predicting user content interest, the method comprising:
receiving user consumption artifacts from one or more behavioral sources;
analyzing received user consumption artifacts;
generating a user-specific content interest list from the received user consumption artifacts; and
generating a potential content playlist for the user from the user-specific content list, wherein the potential content playlist identifies currently available content that is of potential interest to the user.

2. The method of claim 1, further comprising communicating the content interest list and potential content playlist to the user.

3. The method of claim 1, wherein content includes audio content, video content, and/or text content.

4. The method of claim 1, further comprising:
identifying future content that matches the user-specific content interest list; and
alerting the user of the identified future content.

5. The method of claim 4, wherein alerting the user of identified future content comprises sending a message to one or more user devices that identifies a time and location of the future content.

6. The method of claim 4, wherein alerting the user of identified future content comprises sending a message to via email, via SMS (Short Message Service), and/or via MMS (Multimedia Message Service).

7. The method of claim 4, wherein alerting the user of identified future content comprises sending a message to a user device where the user is currently active.

8. The method of claim 5, wherein the message contains a link to the future content.

9. The method of claim 1, wherein content identified by the potential content playlist is available via a communications network.

10. The method of claim 1, wherein analyzing received user consumption artifacts comprises identifying content the user is most likely to consume.

11. The method of claim 1, wherein analyzing received user consumption artifacts comprises determining the number of occurrences of user consumption artifacts.

12. The method of claim 1, wherein generating a user-specific content interest list comprises generating a user-specific content interest list in prioritized order.

13. The method of claim 1, wherein behavioral sources include online content sources, content sources available via stationary media devices, content sources available via mobile media devices, alert messages of identified future content sent to other users, and content interest lists of other users.

14. The method of claim 1, further comprising identifying hypothetical content the user is most likely to consume.

15. The method of claim 1, further comprising syndicating the content interest list and/or potential content playlist to other users.

16. A computer program product for detecting and predicting user content interest, comprising a computer readable storage medium having encoded thereon instructions that, when executed on a computer, cause the computer to perform the following steps:
receiving user consumption artifacts from one or more behavioral sources;
analyzing received user consumption artifacts;
generating a user-specific content interest list from the received user consumption artifacts; and
generating a potential content playlist for the user from the user-specific content list, wherein the potential content playlist identifies currently available content that is of potential interest to the user.

17. The computer program product of claim 16, wherein the computer readable storage medium has encoded thereon instructions that, when executed on a computer, cause the computer to perform the following steps:
identifying future content that matches the user-specific content interest list; and
alerting the user of the identified future content.

18. The computer program product of claim 16, wherein the computer readable storage medium has encoded thereon instructions that, when executed on a computer, cause the computer to identify hypothetical content the user is most likely to consume.

19. A system for detecting and predicting user content interest, comprising an interest engine configured to receive user consumption artifacts from one or more behavioral sources, to analyze received user consumption artifacts, to generate a user-specific content interest list and a potential content playlist for the user, and to communicate the content interest list and potential content playlist to the user, wherein the content playlist identifies currently available content that is of interest to the user.

20. The system of claim 19, further comprising a subscription service that allows other users to subscribe to the content interest list and/or content playlist of the user.
